(19) United States
(12) Patent Application Publication
(10) Pub. No.: US 2005/0074119 A1
(43) Pub. Date: Apr. 7, 2005

(54) Method of producing and viewing 3-dimentional images and secure data encryption/decryption based on holographic means

(76) Inventors: Michael Dziekan, Naugatuck, CT (US); Joseph Bango, New Haven, CT (US)

Correspondence Address: Att: Joseph J. Bango, Jr.;CONN. ANALYTICAL CORP., 696 AMITY ROAD, BETHANY, CT, 06524, US

(21) Appl. No.: 10/891,871

(22) Filed: Jul. 14, 2004

Related U.S. Application Data
(60) Provisional application No. 60/487,561, filed on Jul. 15, 2003.

(51) Int. Cl. H04L 9/00

(52) U.S. Cl. 380/52

(57) ABSTRACT

The invention provides improvements in the way that holograms are created and viewed, and enables the storage of said holograms by digital means, thereby eliminating the requirement of photographic plates or emulsion. The invention also makes possible secure and robust correspondence based on holographic methods and has potential applications to the realization of holographic television, movies, computer displays, cameras, and the enhancement of web sites and virtual reality schemes.

### CROSS REFERENCE TO RELATED APPLICATIONS

Provisional Application No. 60/487,561 was filed on 15 Jul. 2003

### BACKGROUND

1. Field of Invention

The invention provides improvements in the way that holograms are created and viewed, and enables the storage of said holograms by digital means, thereby eliminating the requirement of photographic plates or emulsion and the need for a coherent light source. The invention also makes it possible for secure and robust correspondence to take place based on holographic methods. The invention comprises a method and apparatus for realization of holographic encryption and decryption, a practical means for creating and storing holographic images and text, and eliminating the requirement of a coherent light source for viewing holograms. The invention also has potential applications to the realization of holographic television, movies, computer displays, cameras, and the enhancement of web sites and virtual reality schemes.

2. Background Description of Prior Art

Holography dates from 1947, when British scientist Dennis Gabor developed the theory of holography while working to improve the resolution of the electron microscope. Gabor coined the term hologram from two separate Greek words—‘holos’, meaning “whole,” and ‘gramma’, meaning “message”. Gabor was not able to make a hologram as we know them today because at that time, no acceptable source of coherent light was available and the only monochromatic sources that were used had an exceptionally small coherence lengths (<0.5 mm). Coherence length will be a determining factor in the size of the hologram able to be produced. As a general rule, the longer the coherence length, the better. A good quality frequency stabilized laser available today will have coherence lengths measured in not tenths of a millimeter, but in kilometers!

The coherent light source problem was overcome in 1960 by American scientist Charles Towns with the invention of the laser, whose pure, intense coherent light was ideal for making holograms. The coherence of the laser is absolutely crucial in producing the interference patterns required for the hologram. In 1962 Emmett Leith and Juris Upatnieks of the University of Michigan recognized from their work in side-reading radar, that holography could be used as a 3-D visual medium. In 1962 they read Gabor's paper and “simply out of curiosity” decided to duplicate Gabor's technique using the laser and an “off-axis” technique borrowed from their work in the development of side-reading radar. The result was the first laser transmission hologram of 3-D objects (a toy train and bird). These transmission holograms produced images with clarity and realistic depth but required laser light to view the holographic image. Their pioneering work led to standardization of the equipment used to make holograms. Today, thousands of laboratories and studios possess the necessary equipment: continuous wave laser, optical devices (lens, mirrors and beam splitters) for directing laser light, a film holder and an isolation table on which exposures are made. Stability is absolutely essential because movement as small as a quarter wavelength of light during exposures of a few minutes or even seconds can completely destroy the interference pattern critical to making a hologram. The basic off-axis technique that Leith and Upatnieks developed is still the staple of holographic methodology.

The hologram itself is a layer of photographic emulsion, either on clear flexible plastic material or on a stiff glass backing. For simplicity we will refer to the hologram as a plate. Inspection of a developed hologram plate reveals a remarkable fact—There is nothing on it that resembles the scene. The plate could be quite clear, cloudy, or have dark swirls and striations. Upon inspection of the hologram the obvious question is—Where is the image? In fact, the image is not there at all; rather, it is information about the image coded in the form of interference patterns that are recorded in the hologram. The coded information itself would have no discernable resemblance to the image, even if you could see it with the naked eye. The interference patterns are present only on a microscopic scale and would not be apparent. It is only when the hologram is suitably illuminated that the information contained in the hologram can be decoded and the scene reconstructed or made visible.

Holograms have some very unusual properties associated with them. Besides having a three dimensional appearance, there is the capability of the hologram to store the entire scene throughout the hologram itself. What this means is that one could take a hologram and cover a section of it, or alternatively one could cut or break the hologram into pieces, and each resultant piece of the hologram will contain the original scene or image in its entirety! (See FIG. 8). The only consequence is a reduction in image resolution. When the original hologram is reduced to more and more fragments, the resolution of each fragment is reduced accordingly. Each fragment will appear fuzzier and fuzzier, with a loss of detail and sharpness. A hologram also has the capability to store several scenes. Each separate image on the hologram must have a unique angle between the normal of the photographic surface and the reference beam as indicated in FIG. 1. To view each image contained in the developed hologram, the same angle must be placed between the normal of the hologram surface and the reference beam as indicated in FIG. 2. There are two main kinds of holograms, reflection and transmission. Reflection holograms are viewed by light shining on the front of the plate while transmission holograms are viewed by the light shining through the plate. Reflection holograms work something like a mirror and must be viewed from the same side as the light. Transmission holograms need a monochromatic, coherent light source for viewing, ideally the same type of laser used to produce the hologram in the first place. With transmission holograms the light must pass through the film, so you observe the hologram on the opposite side of the light source.

One limitation to holography is the fact that holograms are always exactly the same size as the original object. This means that holograms of things bigger than the largest plates, about three feet square, cannot be made and reductions are not possible either. When you want to make a copy of a hologram, there are some limitations when compared to conventional photography. Copies are not as easily reproduced. Holograms do not give true color reproduction; their color depends upon the color of the laser used to make the hologram and possibly some artifacting. Using different lasers to light different parts of the objects being pictured creates multicolored images. With the method outlined in this invention by using a CCD, CMOS image sensor or equivalent image sensor technology, the need for a coherent light source can be eliminated to view the hologram, and with the advent of computer generated holograms (CGH), the need for a coherent light source for producing holograms is alleviated. With the current state of high-speed processors, it is quite feasible and economical to produce complicated computer generated holograms (CGH) without the need for a coherent light source. Several points of note are that when sending a message comprised of a digital hologram (that is, a hologram of a two-dimensional picture or sheet of paper with text), only part of the message will need to get through! If only the first half of the message, middle, or last half of the message get through, then the entire message makes it through, albeit at reduced resolution. In a hologram, the “whole” of the message is contained in “part” of the message. A holographic digital data stream will enable very reliable and robust communication.

If the holographic data transmission needs to be secure, then one can send the interference image of the hologram without the necessary reference image needed to decode it. The interference image is comprised of the object beam reflection of the object to be imaged or “holographed”, and the simultaneous interference pattern produced by the reference beam. The combination of these two patterns enables a hologram to be constructed. Since the angle of the reference beam must be duplicated when viewing the hologram to reproduce the image, the receiver of the message or communiqué must know the angle. To ensure greater security, the angle of the reference beam can be altered in a “known” pattern for each word or even letter of a message, or image or subsection of an image. By doing this, an antagonist would be unable to reproduce the original message or image reliably. There can be an equal or greater amount of erroneous text or image data stored in the holographic transmission at deliberately incorrect reference angles, to additionally confuse and thwart an antagonist or enemy. The intended receiver will know ahead of time, the expected pattern of reference angles in their proper sequence. It will even be feasible to encode data with an encryption scheme to further thwart the efforts of an unauthorized interceptor of the message. The secure holographic message or “Holocypher” does not have to be made in the traditional sense of using a laser and holographic plates. A CCD, CMOS image sensor or equivalent image sensor technology can be used in place of a photographic plate, and if the message is not too complicated, the entire process can be done on a computer by creating a computer generated hologram (CGH). The preferred embodiment of this invention would be to use a CGH to encode the message or image. The reference beam angles can be constructed mathematically in a computer comprising literally billions of possibilities that will easily overload even the most clever and skillful code breaker. With additional text encoded into a “Holocypher”, a “would be” antagonist will face an unwieldy amount of data containing valid and erroneous code in the same message. Even if an antagonist were to figure out what the angles were, they would still need to determine the order of those reference angles to view the message. If the antagonist were somehow to determine the contents of the Holocypher, they would be further thwarted by an encryption scheme that could be used to code the original message. To summarize the requirements needed to successfully receive and decode a Holocypher, one would have to do the following;
A) Understand that the message was coded by holographic means in the first place.
B) Know what angles of reference beam are needed to reconstruct each message part.
C) Calculate the pattern of the reference beam for each angle, and appropriate color for each, if not monochromatic.
D) Apply each reference beam pattern to the interference image.
E) Know how many parts of the message there are.
F) Determine which parts are “real” and which parts are “false”.
G) Know what order each part of the message must be placed to reconstruct it.
H) Place all the correct parts of the Holocypher in their correct positions.
I) Apply the correct decryption algorithm needed (if used) to decode the original message or image.
   As one can quickly see, even with the fastest and most powerful supercomputers available, the task of intercepting and gleaning information from a Holocypher will be exceedingly difficult, if not impossible. If the preferred embodiment of using CGH is used, then it will be feasible to create tiny holograms (i.e. small messages), that will be harder to intercept than one huge message. Since all the computations can be done mathematically in a computer, then it is possible to simulate a coherent light source of various wavelengths. Several different colors could be used to further confuse and hinder a “would be” antagonist. Even if an individual or organization was able to determine the proper angles of the reference beams, they might have to deal with different colors of reference beams, and hence, different associated focal lengths. This added twist would further confuse the issue. It is still further possible to create scenarios in the “mathematical space” of the computer, so as to warp or twist the laws of physics, as to make reconstruction of the Holocypher impossible if the method of warping were not known.

If one were to add a “transparent” film or sheet composed of a hologram of the reference beam only to the front of a television or computer monitor, then it would be possible to have a stored holographic interference image as a still image in the form of a BMP, TIFF or JPEG image, or a computer generated “Holo-movie” to appear as a fully three dimensional image from a two dimensional television or monitor. To make the “Holo-movie” one would need to “render” each frame on a computer to create a series of frames. Each frame would need to have calculations run that would calculate how coherent (spatial and temporal) light would reflect off a virtual object and interfere with a virtual reference beam. The software that could do this would be an adaptation of currently existing “Ray tracing” programs, where each frame would be calculated, and then a series of these frames could be strung together to form a video clip. The television or computer monitor that would be used to view this movie would require the transparent holographic sheet of the reference beam to be placed on the front of the screen. Then when the movie or video is played, the viewer will have the “appearance” of viewing a three dimensional scene from a two dimensional screen. The movie or image can also be viewed from virtual reality glasses that circumvent the need for a monitor (liquid crystal or cathode ray tube). The virtual reality experience can be greatly enhanced by the use of holographic technology. To name a few disciplines that would be benefited, are medical and surgical imaging, simulators for aerospace, military, aviation, and civilian training, navigational systems, law enforcement technology, mining and tunneling technology, petroleum exploration, geological studies, entertainment industries, theme parks, arcade facilities, multi-dimensional data analysis, automotive engineering, air traffic controllers, airline pilots, space exploration, astronomy, archeology, mechanical engineering, electrical engineering, architectural design, molecular analysis, molecular biology, protein analysis, genetic engineering, interactive web site development, remote reconnaissance, cartography, computer game design, robotics, 3-D computer operating system, and anatomical studies.

### BRIEF DESCRIPTION OF THE DRAWINGS

FIG. 1 shows a schematic representation of a common method used to create transmission holograms of an object to be recorded onto a photographic emulsion or plate. The angle between the normal of the photographic emulsion or plate and the reference beam from the coherent light source (Laser) is indicated, as this angle determines how the image will be recreated later.

FIG. 2 shows a schematic representation of a common method used to view an image stored in a transmission hologram. The angle between the normal of the developed photographic emulsion or plate and the reference beam from the coherent light source (Laser) is indicated, as this angle is critical in reconstructing the image.

FIG. 3 shows a schematic representation of using a CCD (Charged Coupled Device or equivalent sensor technology) to create transmission holograms of an object to be recorded instead of using a photographic emulsion or plate. The need for a photographic emulsion or plate is unnecessary in this scenario. The angle between the normal of the photographic emulsion or plate and the reference beam from the coherent light source (Laser) is indicated, as this angle determines how the image will be recreated later.

FIG. 4 shows a schematic representation of using a CCD (Charged Coupled Device or equivalent sensor technology) to save the reference beam image of the coherent light source (Laser) for later use in viewing the previously stored transmission hologram shown in FIG. 3. The need for a coherent light source (Laser) is not required in this scenario. The angle between the normal of the CCD, CMOS image sensor or equivalent image sensor and the reference beam from the coherent light source (Laser) is indicated, as this angle is critical in reconstructing the image.

FIG. 5 shows a schematic representation of a series of images that were saved in a computer or camera connected to the CCD (Charged Coupled Device, CMOS image sensor or equivalent sensor technology) as they would appear on the screen of a computer monitor, or some other equivalent graphical output device.

FIG. 6 shows a schematic representation of a new method used to create transmission holograms of an object that will be stored on a computer hard drive or equivalent storage device. The angle between the normal of the CCD (Charged Coupled Device, CMOS image sensor or equivalent sensor technology) and the reference beam from the coherent light source (Laser) is indicated, as this angle determines how the image will be recreated later.

FIG. 7 shows a schematic representation of a series of images that were saved in a computer or camera connected to the CCD (Charged Coupled Device or equivalent sensor technology) as they would appear on the screen of a computer monitor, or some other equivalent graphical output device.

FIG. 8 shows a schematic representation of two holograms, the upper, intact hologram shows an image of a round ball, the lower images show two broken pieces of the above hologram and their respective images if the above hologram were cut or broken in several pieces.

### DETAILED DESCRIPTION OF THE INVENTION

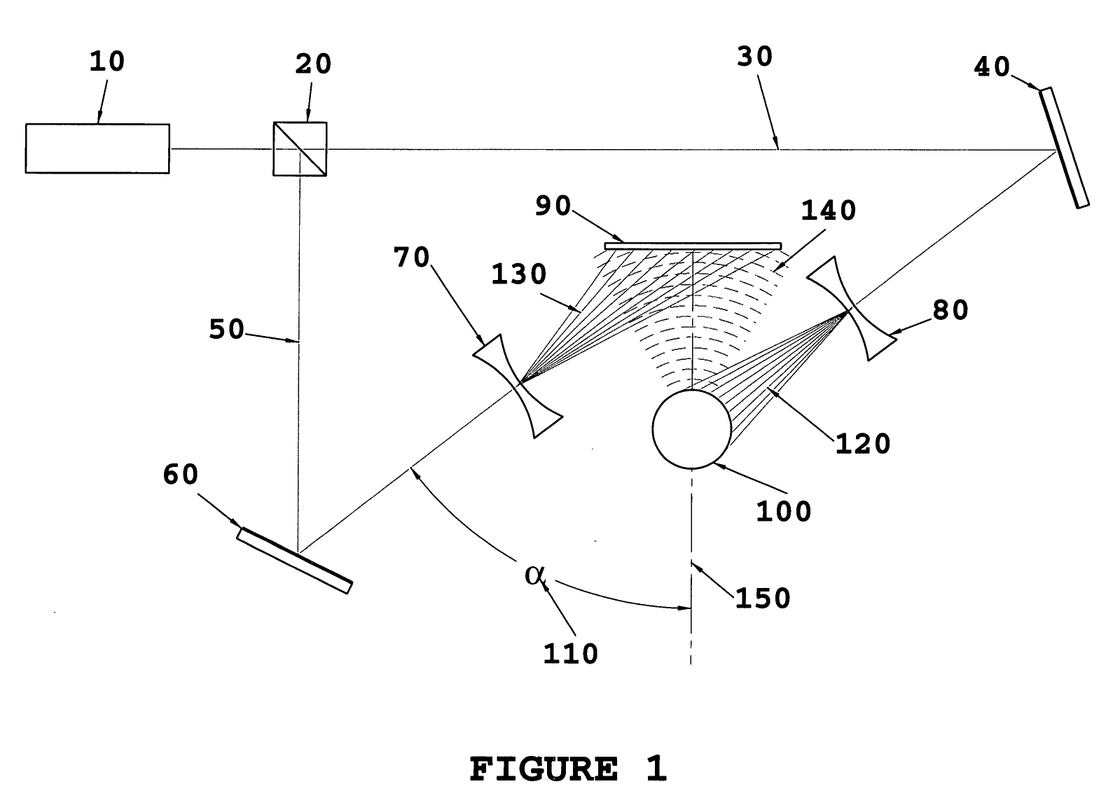

The detailed description of the invention will be separated into four major parts:
A) Holographic creation, storage and viewing via digital means.
B) Holographic encryption and decryption for secure data communications.
C) Transmission and reception of a holographic data transmission.
D) Secure workstation design and usage via holographic means.
   Each topic will be discussed in order from A to D. The first part will detail holographic creation, storage and viewing via digital means.
   Part A)—The creation of modern holograms has been long established and need not be explained in too much detail. FIG. 1 details a typical arrangement for making a coherent light source (laser) viewable transmission hologram. The coherent light source (laser) 10 emits a beam of spatially and temporarily coherent light into a 50/50 beam splitter 20. The beam splitter 20 splits the original beam into two parts, one part will be used to illuminate the object to be “holographed” 100 and is known as the object beam 30, and the other part will be used to illuminate the photographic media 90 and is known as the reference beam 50. The arrangement shown will illuminate the object to be “Holographed” 100 by reflecting the object beam 30 off of a front silvered mirror 40 and expanded to a wide beam spread 120 by a concave lens 80. The wide beam spread 120 will illuminate the object 100 sufficiently for it to register on the photographic media 90 by reflecting the spread out object beam 140 towards the photographic media. The reference beam will in like manor be reflected from another front silvered mirror 60 and passed through a concave lens 70 to spread the beam into a wide beam spread 130. The coherent light reflected from the object 140 and from the spread out reference beam 130 will combine at the photographic media 90 to form both constructive and destructive interference. A key point here is that the path length, i.e. the total distance that the beam must travel from coherent light source (laser) 10 to the photographic media 90, must be kept fairly similar for good results. If both path distance from the object beam 30 and the reference beam 50 are kept very close to each other as measured to the photographic media 90, then a good quality hologram will be produced. The pattern of microscopic interference fringes (invisible to the naked eye) is the recorded scene information, when viewed with a similar coherent light source (laser) at the same angle 110 between the normal to the surface 150 of the photographic media 90 and the reference beam 50 that it was originally created with, the image of the object that was “holographed” will become visible.

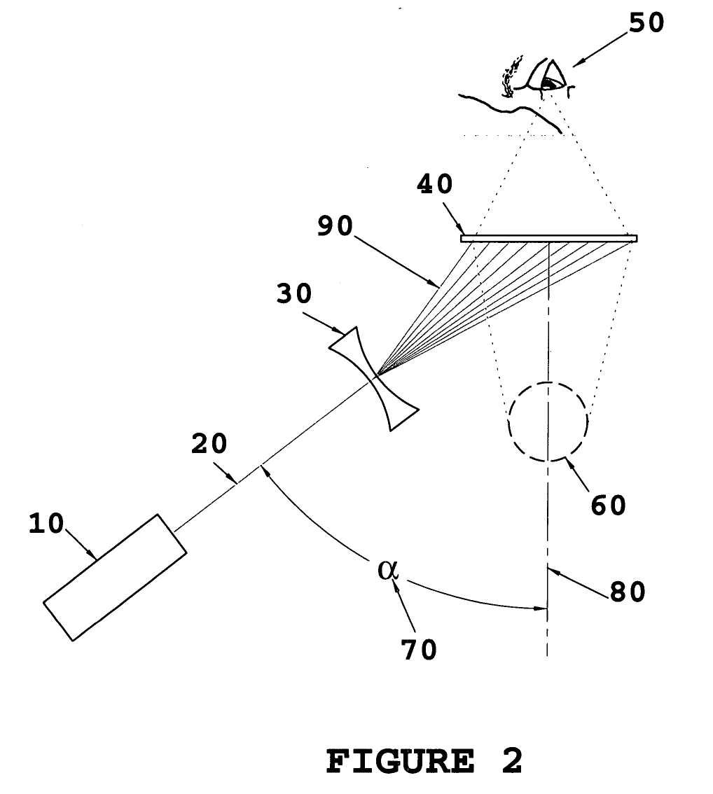

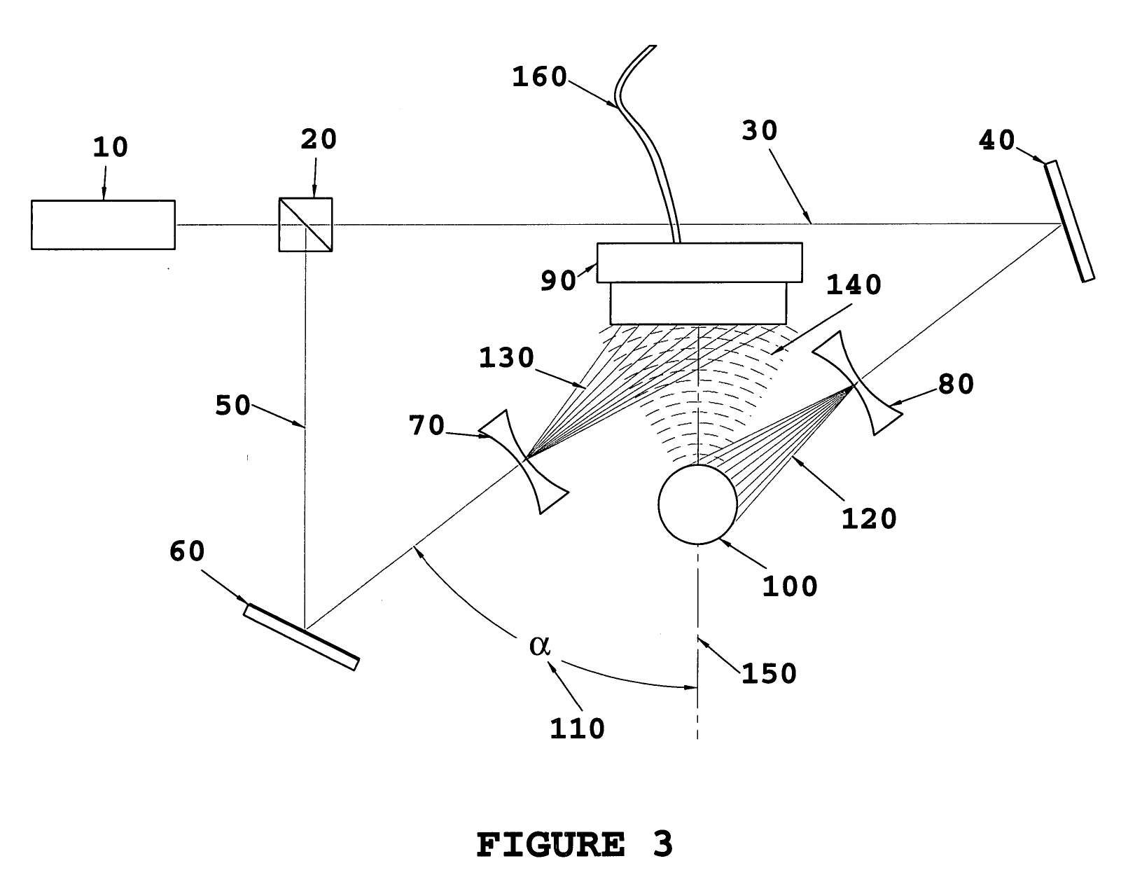

FIG. 2 illustrates this point more clearly. The original photographic media 40 (after proper development and setting of the image) that constitutes the hologram will be placed so that the original angle 70 between the normal of the surface 80 of the photographic media 40 and the coherent light source (laser) 10 will be the same angle 70 that the hologram was originally taken with. The coherent light source (laser) 10 will emit a beam 20 that will be referred to as the reference beam 20, passes through a concave or negative lens 30 to expand the beam 90 so that it covers most, if not all of the photographic media 40. When an observer 50 views the image, they will be parallel to the developed photographic media 40 and on the opposite side from the reference beam 20, to see the image 60 of the original “holographed” object. The image 60 of the original “holographed” object will not become apparent until the angle 70 between the reference beam 20 and the normal to the surface of the photographic media 60 is identical to that of the original setup as indicated in FIG. 1. One of the main thrusts of the invention is to create a digital hologram that will enable it to be stored on compact disk (CD), digital video disk (DVD), computer hard drive, computer floppy disk, ZIP drive, or some other comparable means of data storage, and later be viewed on a computer monitor, television, LCD projection system, virtual reality glasses, or some other comparable means. To effect this end, a similar method of generating holograms is disclosed with the difference of replacing the photographic media with a CCD, CMOS image sensor or equivalent image sensor technology. This change will enable one to store the image or scene information rapidly to a suitable storage device, such as a compact disk (CD), digital video disk (DVD), computer hard drive, computer floppy disk, ZIP drive, or some other comparable means of data storage. By using a CCD, CMOS image sensor or equivalent image sensor technology, the time required to make a hologram will be greatly reduced, and thereby virtually eliminate the possibility of a hologram being ruined by any vibration during the time required to produce a hologram, as would be the case for photographic media. Movements as small as 1/4 of a wavelength of the coherent light (laser) being used to make the hologram could destroy or ruin the final product. The sensitivity to light of a CCD, CMOS image sensor or equivalent image sensor technology is much greater, and thereby much faster than typical holographic photographic media, such as 1 ASA film. FIG. 3 details an arrangement for producing a hologram virtually identical to that as shown in FIG. 1, with the exception being that the photographic media used in FIG. 1 is replaced with a CCD, CMOS image sensor or equivalent image sensor technology.

FIG. 3 details an arrangement for making a coherent light source (laser) viewable transmission hologram. The coherent light source (laser) 10 emits a beam of spatially and temporarily coherent light into a 50/50 beam splitter 20. The beam splitter 20 splits the original beam into two parts, one part will be used to illuminate the object to be “holographed” 100 and is known as the object beam 30, and the other part will be used to illuminate the CCD, CMOS image sensor or equivalent image sensor technology 90 and is known as the reference beam 50. The arrangement shown will illuminate the object to be “Holographed” 100 by reflecting the object beam 30 off of a front silvered mirror 40 and expanded to a wide beam spread 120 by a concave lens 80. The wide beam spread 120 will illuminate the object 100 sufficiently for it to register on the CCD, CMOS image sensor or equivalent image sensor technology 90 by reflecting the spread out object beam 140 towards the CCD, CMOS image sensor or equivalent image sensor technology. The reference beam 50 will in like manor be reflected from another front silvered mirror 60 and passed through a concave lens 70 to spread the beam into a wide beam spread 130. The coherent light reflected from the object 140 and from the spread out reference beam 130 will combine at the CCD, CMOS image sensor or equivalent image sensor technology 90 to form both constructive and destructive interference. A key point here is that the path length, i.e. the total distance that each beam must travel from coherent light source (laser) 10 to the CCD, CMOS image sensor or equivalent image sensor technology 90, must be kept fairly similar for good results. If both path distance from the object beam 30 and the reference beam 50 are kept very close to each other as measured to the CCD, CMOS image sensor or equivalent image sensor technology 90, then a good quality hologram will be produced. The information from the CCD, CMOS image sensor or equivalent image sensor technology 90 will be sent to a suitable data storage device via a connection cable 160, which could be wire, fiberoptic, or a wireless interface. The pattern of microscopic interference fringes (invisible to the naked eye) is the recorded scene information. At this point, to view the image stored in the hologram, one would either print out the “image” (i.e. the unintelligible mess of swirls and loops of lines and dots) stored on the suitable storage device on a high resolution laser printer on a transparent sheet and then view with a similar coherent light source (laser) at the same angle 110 between the normal to the surface 150 of the CCD, CMOS image sensor or equivalent image sensor technology 90 and the reference beam 50 that it was originally created with, the image of the object that was “holographed” will become visible. The transparent sheet printed out by the high-resolution laser printer would be viewed exactly the same way as the photographic media hologram was in FIG. 2.

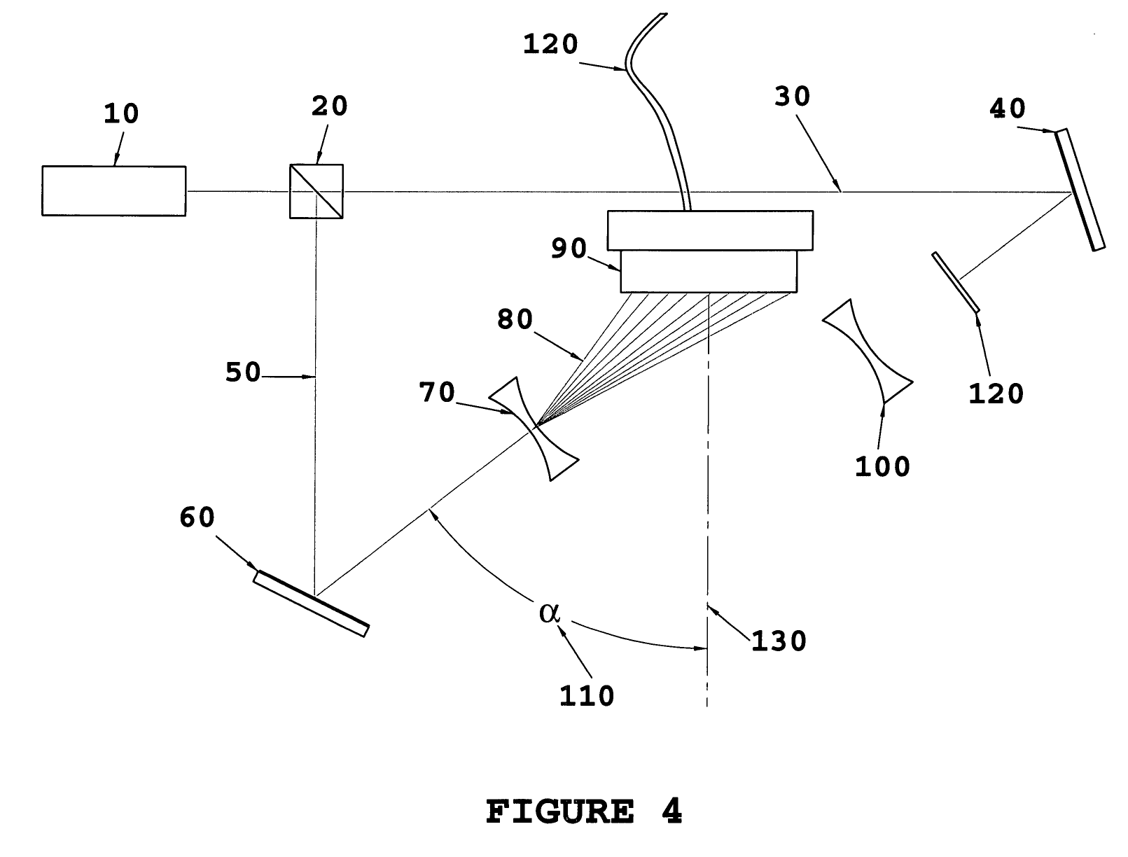

FIG. 4 details the process for storing the reference beam image needed for later viewing or decoding the holographic image. The original hologram setup shown in FIG. 1 can be used (but any similar arrangement will also work) with the exception of the object that was originally “holographed” and the photographic media needed to store the image. FIG. 4 shows the coherent light source (laser) 10 that emits a beam of spatially and temporarily coherent light into a 50/50 beam splitter 20. The beam splitter 20 splits the original beam into two parts, one part will be used to illuminate the object to be “holographed” 100 and is known as the object beam 30, and the other part will be used to illuminate the CCD, CMOS image sensor or equivalent image sensor technology 90 and is known as the reference beam 50. The object beam 30 is not needed in this circumstance, and will be blocked or obstructed by some opaque material 120 to prevent the beam from passing through the concave lens 100. It does not matter if the object beam 30 is blocked before the front silvered mirror 40 or after it as it is shown. The important fact is that the reference beam 50 intensity will remain the same, as it was when the image was “holographed” in FIG. 1. The results will be a better image, but it would work nearly as well if the coherent light source (laser) 10 was projected directly without the use of a beam splitter as it was in FIG. 2. The reference beam 50 is reflected from a front silvered mirror 60 and passed through a concave lens 70 to spread the beam into a wide beam spread 80. Two key points here are that the path length, i.e. the total distance that the beam must travel from coherent light source (laser) 10 to the CCD, CMOS image sensor or equivalent image sensor technology 90, must be kept fairly similar to that of the distance that the object beam 30 would traverse from the coherent light source (laser) 10 to where the object to be “holographed” was placed originally, as in FIG. 3 for good results, and the angle 110 between the normal to the surface 130 of the CCD, CMOS image sensor or equivalent image sensor technology 90 must be kept the same as it was when the original hologram was taken. The only way that an image will be realized will be from the combination of the two stored image patterns taken of the reference beam outlined in FIG. 4 and that of the interference pattern of the original image outlined in FIG. 3. The information from the CCD, CMOS image sensor or equivalent image sensor technology 90 will be sent to a suitable data storage device via a connection cable 120, which could be wire, fiberoptic, or a wireless interface. The image information stored from the CCD, CMOS image sensor or equivalent image sensor technology 90 will be used as a viewing or decoding template to enable the observer to view any image that was “holographed” as outlined in FIG. 3. This template will be known as the “reference template”, without it no image could be seen. The same method of storing the image data sent from the CCD, CMOS image sensor or equivalent image sensor technology outlined in FIG. 3 will be used to store the data from the CCD, CMOS image sensor or equivalent image sensor technology 90 used to store the reference image pattern. To view the original “holographed” object, the image pattern data stored in FIG. 3 and the reference pattern data stored in FIG. 4 must be combined together. The resulting image will be made apparent on a computer monitor, television, LCD projection system, virtual reality glasses, or some other comparable means.

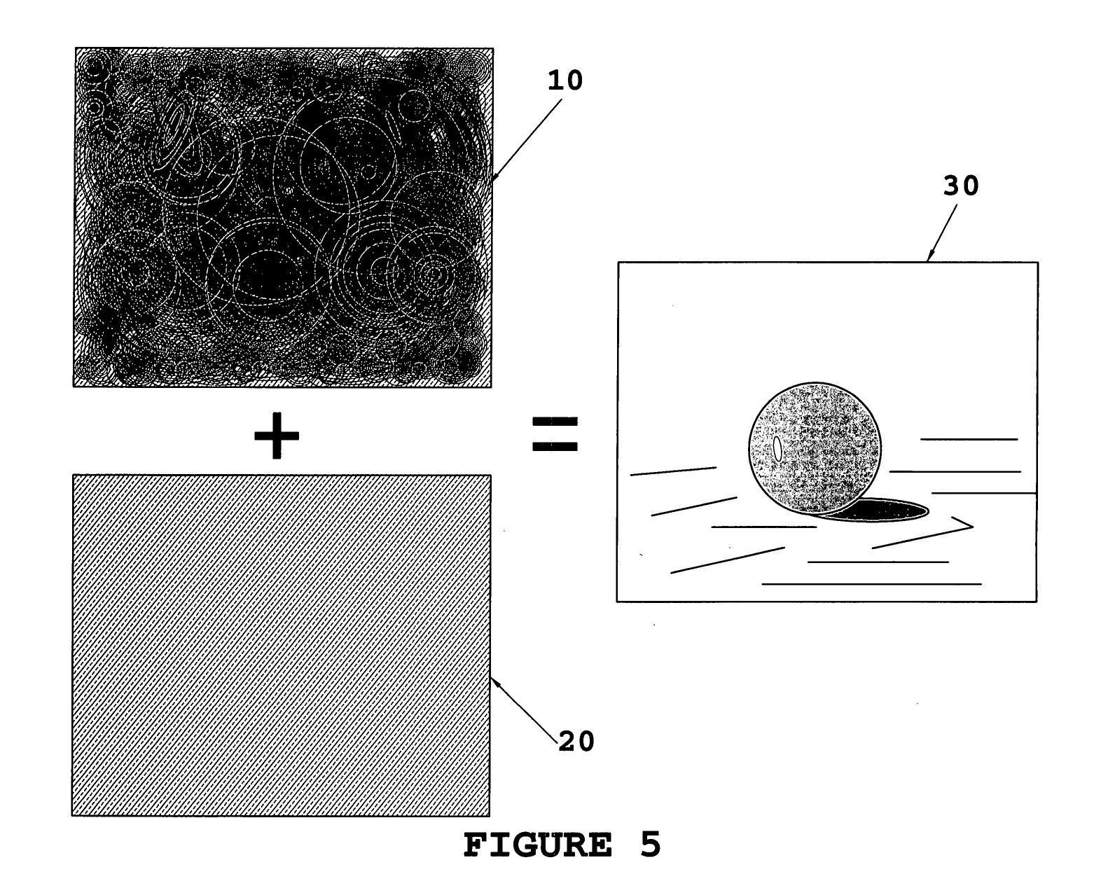

FIG. 5 details an object interference image pattern 10 that was stored according to the process outlined in FIG. 3, and a reference pattern 20 that was stored according to the process outlined in FIG. 4. By summing these two images (by simple addition or a more complex algorithm), the image pattern 10 and the reference pattern 20, point by point, then the resulting combination of the two will display the original image that was “holographed” 30. The resulting image will be made apparent on a computer monitor, television, LCD projection system, virtual reality glasses, or some other comparable means. The images can be stored by a variety of methods commonly used today. Key points to note are that the reference image pattern 20 and the object interference image pattern 10 (hologram or holograph) must be the same size for the combining process to work properly, and also that the angle used between the normal of the surface of the CCD, CMOS image sensor or equivalent image sensor technology used to create the reference image pattern 20 and the object interference image pattern 10 are identical. Every subsequent object interference image pattern 10 (hologram or holograph) that is produced must keep this angle for the reference template 20 to work properly and decode the hologram to view the final image 30. The previous processes outlined all require the use of a coherent light source (laser) to create the reference image pattern and the object interference image pattern. This presents some limitations, such as color. If a true color hologram were desired, then several coherent light sources (lasers) must be used, each with a different wavelength or color. For example, a red coherent light source (laser), a green coherent light source (laser) and a blue coherent light source (laser) are required to produce the hologram. The same red coherent light source (laser), green coherent light source (laser) and blue coherent light source (laser) used to create the hologram, along with their respective reference beam angles are also required to view them. This can be quite complicated and cumbersome to put into practice. With the advent of computer generated holography (CGH), one can create a virtual hologram laboratory to produce images without a “real” coherent light source (laser), or “real” object. One could create holograms of “impossible images” that cannot be done, or cannot be produced practically, such as an iceberg floating on the surface of the sun, or a person standing in the middle of a nuclear explosion while suffering no ill effects. A CGH can have the ability to also create “impossible” coherent light sources. It is not unreasonable to create a fully coherent “white” light source in the virtual holography space in the computer. The reference “mask” or film can also be created mathematically to emulate the same distance and angle that the virtual hologram was created with. With this method, a full color hologram could be produced by CGH. It might be easier to produce the CGH with three separate virtual coherent light sources (i.e. red, green and blue for example) instead of a “white” coherent light source. Computer generated holograms of an object can be produced by computing fringe patterns produced by light interference from the object. Some typical steps involve converting the three-dimensional data of the object to be “holographed” into computational data for fringe pattern generation, then an appropriate sampling rule for sampling the computational data is selected and generating wavefronts by light illumination which are computed by assuming that each sampled position has a light source and finally, fringe patterns are generated. Wavefronts and a reference beam are computed, with fringe patterns stored as hologram images; sampling and a wavefront generation are repeated for all data; and a series of hologram images thus generated are displayed successively. An improvement in virtual reality applications, three-dimensional television, computer monitor displays, and interactive web sites could be realized by utilizing the disclosed invention. By applying a hologram of a reference image pattern from a coherent light source (laser) composed of transparent film or a transparent screen on the front part of a television, computer monitor, or virtual reality glasses, the viewer can experience three dimensional images from a two dimensional source. The details are thus; the reference image pattern that is placed on the television, computer monitor, virtual reality glasses, or comparable viewing device, must be at the same angle as that of the scene that was “holographed” originally. An example would be that of a toy ball, the original toy ball would be “holographed” as outlined in FIG. 3 and saved as a digital image, such as a BMP, JPEG, TIFF, TGA, PICT, or some similar image format and then displayed on the television, computer monitor, virtual reality glasses, or comparable viewing device that has the applied transparent film or a transparent screen which holds the reference image pattern (hologram). The interaction of the applied transparent film or a transparent screen reference image pattern (hologram) and the displayed “holographed” image would combine to reveal the original image of the toy ball, although it will have the appearance of a three dimensional object. The applied transparent film, transparent screen, or mask of the reference image pattern (hologram) must be positioned on the television, computer monitor, virtual reality glasses, or comparable viewing device so as to interact fully with the “holographed” image being displayed. The enhanced three dimensional appearance will be of great benefit to a wide array of disciplines like medical and surgical imaging, simulators for aerospace, military, aviation, and civilian training, navigational systems, law enforcement technology, mining and tunneling technology, petroleum exploration, geological studies, entertainment industries, theme parks, arcade facilities, multi-dimensional data analysis, automotive engineering, air traffic controllers, airline pilots, space exploration, astronomy, archeology, mechanical engineering, electrical engineering, architectural design, molecular analysis, molecular biology, protein analysis, genetic engineering, interactive web site development, remote reconnaissance, cartography, computer game design, robotics, 3-D computer operating system, and anatomical studies.

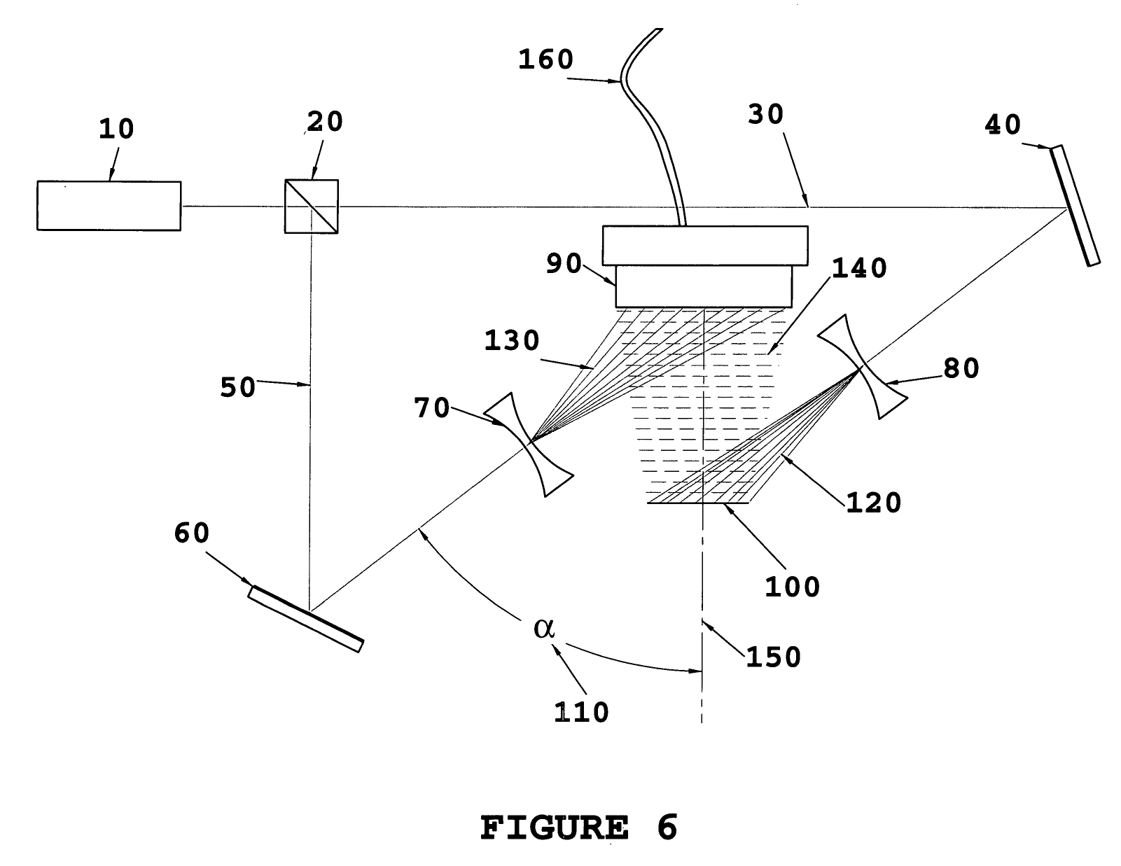

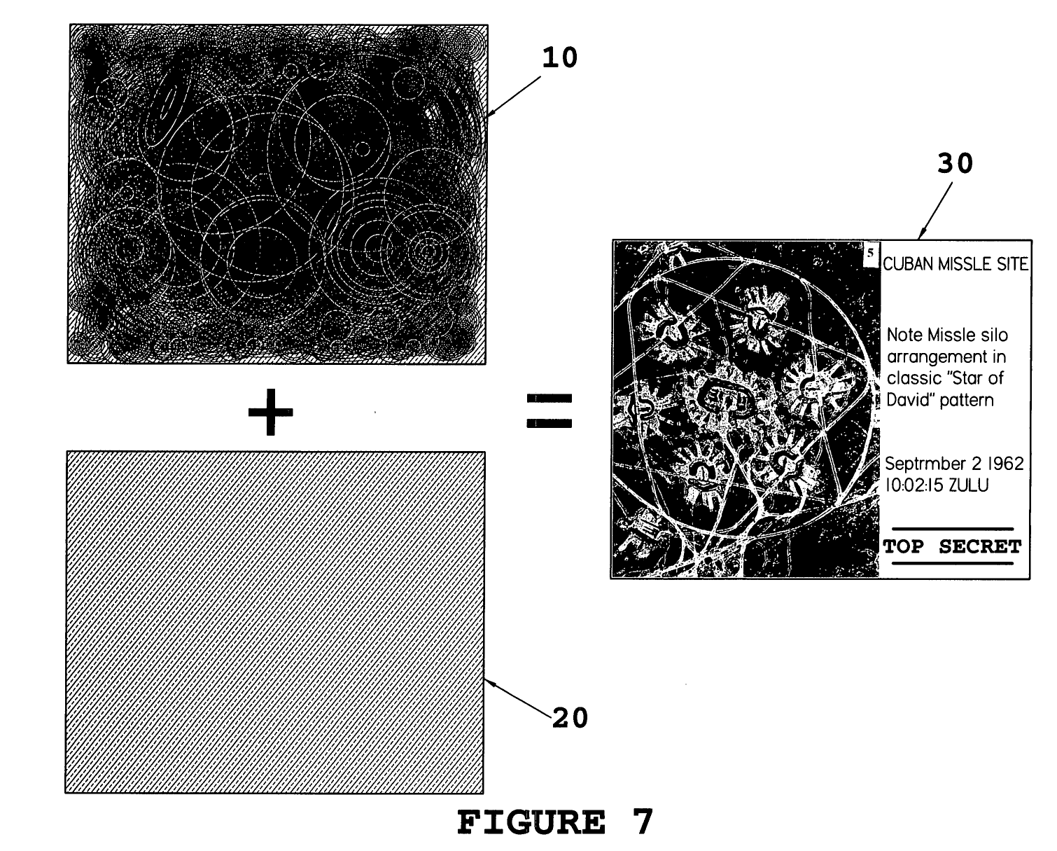

Part B)—The next part of the disclosed invention will deal with holographic encryption and decryption for secure data communications. There exists a plethora of clever encryption and decryption schemes intended for preventing unauthorized access to secure data. This invention proposes a new and unique scheme for data encryption and decryption utilizing holographic methodologies and will be refereed to as a “Holocypher”. FIG. 6 outlines a process for “holographing” a document or photograph 100 similar to FIG. 3. A coherent light source (laser) 10 emits a beam of spatially and temporarily coherent light into a 50/50 beam splitter 20. The beam splitter 20 splits the original beam into two parts, one part will be used to illuminate the object to be “holographed” 100 and is known as the object beam 30, and the other part will be used to illuminate the CCD, CMOS image sensor or equivalent image sensor technology 90 and is known as the reference beam 50. The arrangement shown will illuminate the object to be “Holographed” 100 by reflecting the object beam 30 off of a front silvered mirror 40 and expanded to a wide beam spread 120 by a concave lens 80. The wide beam spread 120 will illuminate the object 100 sufficiently for it to register on the CCD, CMOS image sensor or equivalent image sensor technology 90 by reflecting the spread out object beam 140 towards the CCD, CMOS image sensor or equivalent image sensor technology. The reference beam will in like manor be reflected from another front silvered mirror 60 and passed through a concave lens 70 to spread the beam into a wide beam spread 130. The coherent light reflected from the object 140 and from the spread out reference beam 130 will combine at the CCD, CMOS image sensor or equivalent image sensor technology 90 to form both constructive and destructive interference. A key point here is that the path length, i.e. the total distance that the beam must travel from coherent light source (laser) 10 to the CCD, CMOS image sensor or equivalent image sensor technology 90, must be kept fairly similar for good results. If both path distance from the object beam 30 and the reference beam 50 are kept very close to each other as measured to the CCD, CMOS image sensor or equivalent image sensor technology 90, then a good quality hologram will be produced. The information from the CCD, CMOS image sensor or equivalent image sensor technology 90 will be sent to a suitable data storage device via a connection cable 160, which could be wire, fiberoptic, or a wireless interface. The pattern of microscopic interference fringes (invisible to the naked eye) is the recorded scene information. At this point, viewing the image stored in the hologram without the required reference image would appear as an unintelligible mess of swirls, loops, lines and dots that cannot be interpreted as the original stored document or photograph since there is no resemblance. By itself it would be virtually impossible to decode the image and view the original scene, the addition of several methodologies will further frustrate an antagonist or unauthorized individual from gaining intelligence from a “Holocypher”. To ensure secure access to only authorized individuals, an additional form of security could be utilized to “encrypt” a message as a “Holocypher”. By using CGH to produce the message to be encoded as a “Holocypher”, it would be no great difficulty to encode each letter or character of the message separately by using separately calculated reference beam at a different angle for each. That is to say that since one is working in a virtual environment for making these “Holocyphers”, then a virtual reference beam can be calculated at any angle wished. The interference pattern for the combination of the virtual reference beam and the virtual text to be encoded would be stored in the “Holocypher”. The exact angle of the reference beam must be known to reproduce the original image that was “Holographed” as a CGH. In order to recover this information, the receiver would need to have the original “Holocypher”, and the details of the order of the representative angle of reference beam were used to produce the “Holocypher” in the first place. A suitable pseudorandom algorithm could be known to both the sender and intended receiver that will detail the sequence of what angles would be needed for recovery of the “Holocypher” data. To properly decode the message, each angle of “virtual” reference beam would need to be processed with the original “Holocypher” to decode each letter or character. An example of such an encoding of a “Holocypher” would be made as in FIG. 6. An image 100 containing text or graphical information is “holographed” by the interference patterns generated by the combination of the reference beam 50 and the object beam 30. Although this arrangement shows a real laboratory setup (i.e. it is not a virtual mathematical computer environment that one would use to create CGH), the preferred embodiment of this invention would be to employ techniques used to produce CGH (computer generated holograms). By producing “Holocyphers” totally in the virtual mathematical environment of a computer, the use of “Holocyphers” would be greatly simplified. When a “Holocypher” is created and sent, it would appear as detailed in FIG. 7. The interference pattern 10 of the original image that was “holographed” is sent to the intended receiver. The pattern of interference fringes 10 of the original image are unintelligible and do not convey any information to the original scene, text, or image that was “holographed”. The intended receiver would have a copy of the digital image of the stored reference pattern 20 that was produced by the same reference beam angle used to create the “hologram” in the first place. (This specific example details a very low level of security transmission in which none of the previously mentioned techniques were used to scramble and encrypt the “holograph”, and is shown just to show a simple “decoding” of an image). The intended receiver has a copy of the digital image of the stored reference pattern 20 produced at the same angle that the original image 30 was “holographed” with. The receiver would then combine the images of the pattern of interference fringes 10 of the original image with the digital image of the stored reference pattern 20 to enable the original final image 30 to be obtained. Some additional layers of security that could be used to provide a higher level of security, would be to “shuffle” the image data points by a known pseudorandom algorithm that the authorized sender and receiver would both know. If the receiver would be able to gain access to the “Holocypher” data and not know what the algorithm was used to shuffle the data, then their efforts to gather intelligence would be greatly hampered. Current encryption schemes such as RSA coding or similar forms could also be used to encrypt the data sent as a “Holocypher”. This would enable an additional layer of security to be realized to ensure private and secure communications. Still other levels of security could be obtained by purposely adding “fake” or false message data at angles of reference beam that the pseudorandom algorithm will not use, and are there solely to confuse an individual or organization that is not intended to receive this message. Only the intended receiver with the proper pseudorandom algorithm for determining what angles of reference beam to use, and in what order will be able to access the information.

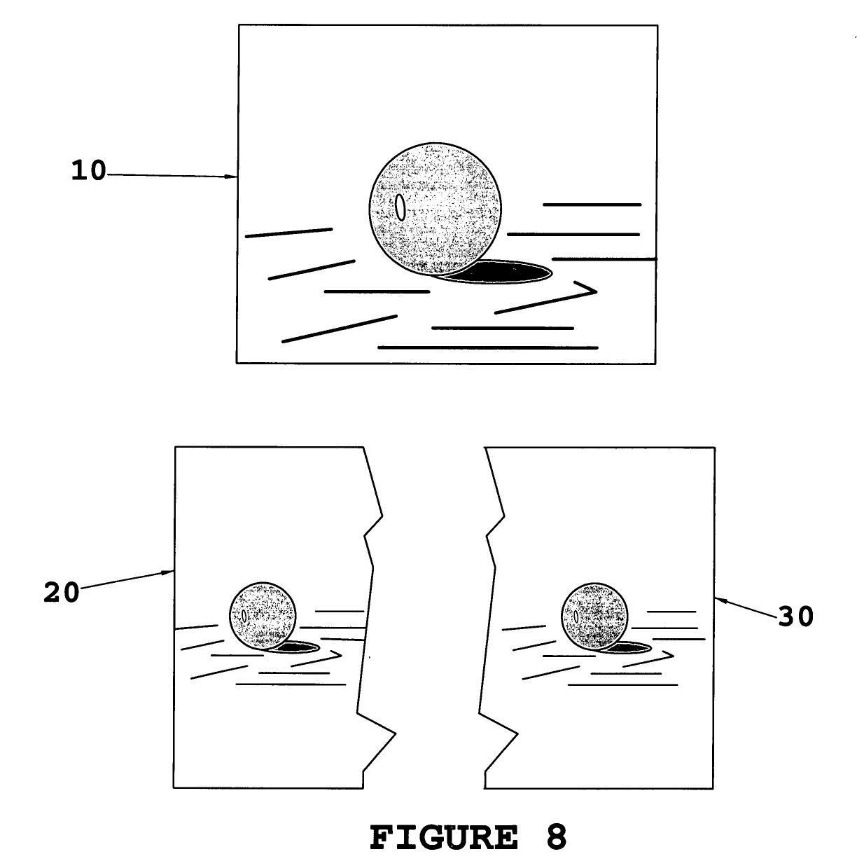

Without knowing the following several key items, it will be extremely difficult if not impossible to view the original document or photograph.
A) Understand that the message was coded by holographic means in the first place.
B) Know what angles of reference beam are needed to reconstruct each message part.
C) Calculate the pattern of the reference beam for each angle.
D) Apply each reference beam pattern to the interference image.
E) Know how many parts of the message there are.
F) Determine which parts are “real” and which parts are “false”.
G) Know what order each part of the message must be placed to reconstruct it.
H) Place all the correct parts of the Holocypher in their correct positions.
I) Apply the correct decryption algorithm needed (if used) to decode the original message or image.
   Part C)—The next part of the disclosed invention will deal with holographic transmission and reception of data communications. Holograms have many interesting and unique features. If a transmission hologram is cut or broken into pieces, then each individual piece will contain the entire scene or image. As FIG. 8 details, the original hologram 10 is viewed by the same coherent light source (laser) and reference beam angle that was used to create the hologram in the first place. When the angle of the coherent light source (laser) is matched to that used to create the hologram in the first place, then the image will become visible. If the hologram were broken into two or more pieces (20 and 30), then each subsequent piece (20 and 30) would contain the “whole” of the scene, or complete image, albeit at a reduced level of sharpness or resolution. All of the original scene elements are contained in each image portion (20 and 30), but they would each appear slightly fuzzy. As more and more pieces were produced from the original or master hologram, then each subsequent image would become fuzzier and fuzzier. With the help of image recognition or optical character recognition (OCR), then the details of the original image could be restored (although the three dimensional appearance would be lost) to a form where the original message or photograph could still be produced. This special feature (image or information redundancy) of holograms constitutes the third topic of this invention, that of robust and self-redundant communications. If a hologram is produced by digital means like that detailed in FIG. 6, or by CGH, then an image is produced of the type detailed in FIG. 7 (10). If this image is transmitted through some means (wireless, fiberoptic, or wired), then only a portion of the image 10 need to be received. If some type of jamming process or interrupted communications is encountered, then the entire message 30 will be able to be reconstructed. Although the amount of message that makes it through will determine the quality of the final image 30, the key point here is that all of the message gets through with only a small part of the original 10 interference pattern. When the same reference pattern 20 is combined with the portion of the original interference pattern 10 that makes it thorough to the receiver, then the whole of the message is realized. With more of the original 10 interference pattern that makes it through, then the sharpness and quality of the final image 30 will be improved.
   Part D)—Yet another application of the disclosed invention will deal with a method to provide secure workstation access and usage via holographic means, in addition to enabling secure video and voice transmission for video conferencing. A good security paradigm is only as good as its weakest point, and sadly this “weakest point” is usually caused by human error. Some of the greatest encryption devices of World War II such as the famous German Enigma cipher machine were compromised due to operator error while using them in the field. The radio operator used the same key several times, while ignoring the fact that they were told to use a different key each day. This and the fact that they sent out many more messages than they were authorized to do gave the Polish, English and American code breakers a great deal of linked ciphers to work with and try to parse out a pattern to the coding scheme. Were it not for the arrogance of the German Nazi mentality for believing that they were invincible, it would have been perhaps several more months to even years before a method was devised to break the enigma cipher. There exists today this same vulnerability for a perfectly sound and secure method for exchanging secure correspondence or viewing secure materials due to human error. One way that this invention proposes to help remove the “weak link” element out of sensitive, classified, secret and top secret methodologies is to enable an encryption scheme to be used on computer workstations. If a common CRT (Cathode ray tube) computer monitor is used to view sensitive material, then there exists a way to gain access to that information remotely via the RF (radio frequency) emitted by the CRT. A technology exists today that is specifically designed for the purpose of decoding the emitted RF from CRT's, it is called TEMPEST. The word TEMPEST is an acronym for Transient ElectroMagnetic Pulse Emanating Surveillance Technology, and this technology has been around since the 1950's. Currently (at least as far as one without a top secret clearance knows) only the CRT type of monitor is vulnerable to this type of “information leakage” due to RF, but it stands to reason that with more sophisticated and sensitive electronics, it will only be a matter of time (if not done already) before the information displayed on an LCD (liquid crystal display) will be made vulnerable to this same “information leakage”. If the information that is to be displayed on the computer or video monitor is “encrypted” holographically, then even if an antagonist or unauthorized individual or agency has access to the emitted RF from the monitor, then it will do them no good! In order to view the information, the same methodology that was used in part A to create a transparent film or screen that can be placed on the front of a computer monitor, television, virtual reality glasses or video monitor to produce a three dimensional image, can be used to visually encrypt the video information. If all the video sent to the monitor is coded as a holographic interference pattern, with the only way of viewing it properly by using a special transparent screen or film mounted directly to the front of the monitor, then even if the RF was able to be intercepted by an antagonist or unauthorized individual or agency, it would appear to them as a meaningless, scrambled mess of lines, loops, and points, instead of any intelligible information. With this invention, one has created a secure computer workstation or “Holoplatform” intended for the viewing of secure documents or images. If the documents or images are stored as a holographic interference pattern that will only become intelligible when combined with the correct reference beam pattern that has been placed on the front of the monitor, then even if those images or documents are lost or stolen, without the proper reference beam pattern, it will come to no avail. By using this methodology to restrict certain computers as secure or qualified for use for viewing sensitive, classified, secret and top secret documents, then the level of security of a designated area could be maintained, despite human error. The military has specially designated areas for viewing and handling secure data; it is called a Secure Compartment Information Facility (SCIF). With the use of this invention, then it would be possible to effect a higher level of security for ordinary work areas for military, commercial, financial and government operations. A bank or financial institution will gain an additional level of security by employing the disclosed invention to encode visual information via holographic means, in addition to online shopping and e-commerce. The level of security can be greatly enhanced by allowing only “designated” workstations to be used for specific secure functions. If a “would be” hacker were to successfully break into the computer system, then their efforts would be frustrated by the fact that all of the files and even the operating system would be holographically encoded. Without the appropriate transparent reference beam film or screen on the “would be” hackers' computer, then the information would be of no use. A secure video conference could be effected by employing the disclosed invention, by converting the video and speech to a holographic interference pattern, and allowing the transparent reference beam film or screen that is mounted on both screens to decode the video. The beauty of this system is that even though the encoding consumes some computer processing time, the decoding is all done optically, so it is instantaneous. The audio portion can be encoded through a computer algorithm that would mimic the process for creating a hologram as outlined in part A and part D. This invention can be expanded to encode packets of information that are used in a computer network, cell phone switching network, cordless phones, pagers, walkie talkies, wireless communication, fiberoptic communications, wired communications, secure communication between sensors and intelligent security panel, and even as a method to enable secure web surfing. By using a small decoding program that could be resident on a computer, the entire contents of a hard drive could be encoded holographically. It would not be unreasonable to create a new writable “Holodisk” that would store information similar to a compact disk (CD) or digital video disk (DVD) by holographic means. Using the disclosed invention could enhance the additional storage of information and enable a “Holocode” to be placed on each optical CD or DVD. This new digital Holodisk (DHD) would enable the company that produced the software to place a security “Holocode” to prevent copying or reproduction by unauthorized individuals. The “Holodisk” player could have a movable coherent light source (laser) that would enable a variable reference beam to take a snapshot of a portion of the DHD to determine whether it is a valid DHD or an illegal copy.
   Reference Numerals:
   FIG. 1:
10 Coherent light source (Laser).
20 Beam splitter (50/50).
30 Object beam that will be used to illuminate the object to be imaged (created from the beam splitter).
40 First or Front surface mirror with front surface on the side of the beam, and will be used to redirect the beam. The first or front silvered mirror is necessary to eliminate multiple reflections that would be caused by a second or back silvered mirror.
50 Reference beam that will be used to illuminate the photographic emulsion or plate and create the interference pattern necessary to create a hologram (created from the beam splitter).
60 First or Front surface mirror with front surface on the side of the beam, and will be used to redirect the beam. The first or front silvered mirror is necessary to eliminate multiple reflections that would be caused by a second or back silvered mirror.
70 Beam expanding lens that will cause the coherent light source (Laser) beam to diverge. This could be a single or compound lens.
80 Beam expanding lens that will cause the coherent light source (Laser) beam to diverge. This could be a single or compound lens.
90 Photographic emulsion or photographic plate (previously unexposed) needed to store the interference patterns that will comprise the hologram. The photographic emulsion or photographic plate must later be processed by typical photographic means to develop the image.
100 Object to be imaged by the Object and Reference beam from the coherent light source (Laser).
110 Angle between the normal of the photographic emulsion or plate and the reference beam from the coherent light source (Laser) is indicated, as this angle determines how the image will be recreated later.
120 The object beam from the coherent light source (Laser) is shown as it diverges from the lens.
130 The reference beam from the coherent light source (Laser) is shown as it diverges from the lens.
140 The light reflected off the object to be imaged is shown.
150 An imaginary center line to reference the normal of the photographic emulsion, or photographic plate is indicated.
   FIG. 2:
10 Coherent light source (Laser).
20 Reference beam that will be used to view the stored holographic object
30 Beam expanding lens that will cause the coherent light source (Laser) beam to diverge. This could be a single or compound lens.
40 Photographic emulsion or photographic plate (previously exposed and developed).
50 Observer or viewer looking at the photographic emulsion or photographic plate.
60 Virtual object that would appear to be seen by an observer or viewer.
70 Angle between the normal of the photographic emulsion or plate and the reference beam from the coherent light source (Laser) is indicated. This angle must be the same as that of the reference beam that was used to create the original hologram.
80 An imaginary center line to reference the normal of the photographic emulsion, or photographic plate is indicated.
90 The reference beam from the coherent light source (Laser) is shown as it diverges from the lens.
   FIG. 3:
10 Coherent light source (Laser).
20 Beam splitter (50/50).
30 Object beam that will be used to illuminate the object to be imaged (created from the beam splitter).
40 First or Front surface mirror with front surface on the side of the beam, and will be used to redirect the beam. The first or front silvered mirror is necessary to eliminate multiple reflections that would be caused by a second or back silvered mirror.
50 Reference beam that will be used to illuminate the CCD (Charged Coupled Device, CMOS image sensor or equivalent sensor technology) to create the interference pattern necessary to create a hologram.
60 First or Front surface mirror with front surface on the side of the beam, and will be used to redirect the beam. The first or front silvered mirror is necessary to eliminate multiple reflections that would be caused by a second or back silvered mirror.
70 Beam expanding lens that will cause the coherent light source (Laser) beam to diverge. This could be a single or compound lens.
80 Beam expanding lens that will cause the coherent light source (Laser) beam to diverge. This could be a single or compound lens.
90 CCD (Charged Coupled Device, CMOS image sensor, or equivalent sensor technology) that will be used to convert the incident light into an electrical signal for later storage.
100 Object to be imaged by the Object and Reference beam from the coherent light source (Laser).
110 Angle between the normal of the CCD (Charged Coupled Device, CMOS image sensor, or equivalent sensor technology) and the reference beam from the coherent light source (Laser) is indicated, as this angle determines how the image will be recreated later.
120 The object beam from the coherent light source (Laser) is shown as it diverges from the lens.
130 The reference beam from the coherent light source (Laser) is shown as it diverges from the lens.
140 The light reflected off the object to be imaged is shown.
150 An imaginary center line to reference the normal of the CCD (Charged Coupled Device, CMOS image sensor, or equivalent sensor technology) is indicated.
160 Connection between the image sensor (CCD—Charged Coupled Device or equivalent sensor technology) that will enable a suitable storage device to record the resultant image.
   FIG. 4:
10 Coherent light source (Laser).
20 Beam splitter (50/50).
30 Object beam that will be used to illuminate the object to be imaged (created from the beam splitter).
40 First or Front surface mirror with front surface on the side of the beam, and will be used to redirect the beam. The first or front silvered mirror is necessary to eliminate multiple reflections that would be caused by a second or back silvered mirror.
50 Reference beam that will be used to illuminate the image sensor (CCD —Charged Coupled Device, CMOS image sensor or equivalent technology) to create the interference pattern necessary to view the hologram.
60 First or Front surface mirror with front surface on the side of the beam, and will be used to redirect the beam. The first or front silvered mirror is necessary to eliminate multiple reflections that would be caused by a second or back silvered mirror.
70 Beam expanding lens that will cause the coherent light source (Laser) beam to diverge. This could be a single or compound lens.
80 The reference beam from the coherent light source (Laser) is shown as it diverges from the lens. This could be a single or compound lens.
90 CCD (Charged Coupled Device, CMOS image sensor or equivalent sensor technology) that will be used to convert the incident light into an electrical signal for later storage.
100 Beam expanding lens that will cause the coherent light source (Laser) beam to diverge. This could be a single or compound lens.
110 Angle between the normal of the CCD (Charged Coupled Device, CMOS image sensor, or equivalent sensor technology) and the reference beam from the coherent light source (Laser) is indicated, as this angle determines how the image will be recreated later.
120 Connection between the image sensor (CCD—Charged Coupled Device or equivalent sensor technology) that will enable a suitable storage device to record the resultant image.
   FIG. 5:
10 Stored image of interference pattern comprising the reflected coherent object beam from the object to be imaged and the coherent reference beam. The image is stored as a formatted digital image from the output of an image sensor (CCD—Charged Coupled Device, CMOS image sensor or equivalent sensing technology).
20 Stored image of reference pattern from the coherent reference beam. The image is stored as a formatted digital image from the output of an image sensor (CCD—Charged Coupled Device, CMOS image sensor or equivalent sensing technology).
30 Final image of originally imaged object due to the combination of the stored reference image and the stored interference pattern.
   FIG. 6:
10 Coherent light source (Laser).
20 Beam splitter (50/50).
30 Object beam that will be used to illuminate the object to be imaged (created from the beam splitter).
40 First or Front surface mirror with front surface on the side of the beam, and will be used to redirect the beam. The first or front silvered mirror is necessary to eliminate multiple reflections that would be caused by a second or back silvered mirror.
50 Reference beam that will be used to illuminate the image sensor (CCD —Charged Coupled Device, CMOS image sensor or equivalent technology) to create the interference pattern necessary to create a hologram (created from the beam splitter).
60 First or Front surface mirror with front surface on the side of the beam, and will be used to redirect the beam. The first or front silvered mirror is necessary to eliminate multiple reflections that would be caused by a second or back silvered mirror.
70 Beam expanding lens that will cause the coherent light source (Laser) beam to diverge. This could be a single or compound lens.
80 Beam expanding lens that will cause the coherent light source (Laser) beam to diverge. This could be a single or compound lens.
90 CCD (Charged Coupled Device, CMOS image sensor or equivalent sensor technology) that will be used to convert the incident light into an electrical signal for later storage.
100 Object to be imaged by the Object and Reference beam from the coherent light source (Laser).
110 Angle between the normal of the CCD (Charged Coupled Device, CMOS image sensor, or equivalent sensor technology) and the reference beam from the coherent light source (Laser) is indicated, as this angle determines how the image will be recreated later.
120 The object beam from the coherent light source (Laser) is shown as it diverges from the lens.
130 The reference beam from the coherent light source (Laser) is shown as it diverges from the lens.
140 The light reflected off the object to imaged is shown.
150 An imaginary center line to reference the normal of the CCD (Charged Coupled Device, CMOS image sensor, or equivalent sensor technology) is indicated.
160 Connection between the image sensor (CCD—Charged Coupled Device or equivalent sensor technology) that will enable a suitable storage device to record the resultant image.
   FIG. 7:
10 Stored image of interference pattern comprising the reflected coherent object beam from the object to be imaged and the coherent reference beam. The image is stored as a formatted digital image from the output of an image sensor (CCD—Charged Coupled Device, CMOS image sensor or equivalent sensing technology).
20 Stored image of reference pattern from the coherent reference beam. The image is stored as a formatted digital image from the output of an image sensor (CCD—Charged Coupled Device, CMOS image sensor or equivalent sensing technology).
30 Final image of originally imaged object due to the combination of the stored reference image and the stored interference pattern.
   FIG. 8:
10 Transmission Hologram of an object (in this case a round toy ball).
20 Broken section of above transmission hologram showing full image while only half of the original hologram is shown.
30 Broken section of above transmission hologram showing full image while only half of the original hologram is shown.

1. a method of creating holograms without the need for physical photographic media

2. a method of digitizing holographic images and data

3. a method of encrypting and decrypting digital data created by holographic means

4. a method of creating a holographic template for the purposes of viewing three dimensional holographic data on a two dimensional display
